(19) United States
(12) Patent Application Publication
(10) Pub. No.: US 2002/0083323 A1
(43) Pub. Date: Jun. 27, 2002

(54) Method and system for enabling an image to be authenticated

(76) Inventors: Daryl Carvis Cromer, Apex, NC (US); Richard Alan Dayan, Wake Forest, NC (US); Howard Jeffrey Locker, Cary, NC (US); Andy Lloyd Trotter, St. Raleigh, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(21) Appl. No.: 09/746,829

(22) Filed: Dec. 22, 2000

(51) Int. Cl. H04L 9/00

(52) U.S. Cl. 713/176

(57) ABSTRACT

A method and system for enabling an image to be authenticated is disclosed. The method and system comprise providing a digital signature associated with a device, allowing a user to capture the image utilizing the device and associating the digital signature and information related to the user with the captured image wherein the digital signature and the information related to the user are capable of being utilized to authenticate the captured image. Through the use of the method and system in accordance with the present invention, digital images can be captured whereby the digital signature of the capturing device, as well as information related to the photographer (i.e. name, company, etc.), are associated with the captured image. By associating the digital signature of the camera, as well as information related to the photographer, with the captured image, the subsequent authentication of the digital image is more reliable.

### FIELD OF THE INVENTION

The present invention relates to generally to the electronic transmission of digital images and particularly to a method and system for enabling an image to be authenticated.

### BACKGROUND OF THE INVENTION

Traditional analog still cameras capture an image on 35 mm or some other photographic film format as the actual picture. The image is transferred to film because the film is sensitive to light. Frequently, photographers place identification and copyright information on the back of the photograph whereby unauthorized reproductions are easily detected.

A digital camera is a video or still camera that records images in digital form. FIG. 1 shows a typical digital camera configuration 10. The configuration 10 comprises a DSP chip 12, an Analog/Digital converter (ADC) chip 14, a charged couple device (CCD) 16, a lens 18 and memory components 20.

Behind the lens 18, the CCD 16 picks up the image as charges that are converted to digital data by the ADC chip 14. The DSP chip 12 adjusts contrast and detail and compresses the digital data for storage. Unlike traditional analog cameras that record infinitely-variable intensities of light, digital cameras record discrete numbers for storage on flash memory card, floppy disk or hard disk. As with all digital devices, there is a fixed, maximum resolution and number of colors that can be represented. The images can then be transferred to a computer with a serial cable, USB cable or via the storage medium itself if the desktop machine has the appropriate software.

Digital cameras record color images as intensities of red, green and blue, which are stored as variable charges in the CCD matrix. The size of the matrix determines the resolution, but the ADC which converts the charges to digital data, determines the color depth.

Ease of capture, archiving, sharing and especially manipulation are features inherent to digital images and are attractive features from the standpoint of customers. However, these same features make digital image data extremely susceptible to unauthorized altering. In applications where digital images are captured for purposes of establishing a record, such as property and casualty applications in the insurance industry, the authenticity of the image is of extreme importance.

Accordingly, what is needed is a method and system for enabling an image to be accurately authenticated. The method and system should be simple, cost effective and capable of being easily adapted to current technology. The present invention addresses such a need.

### SUMMARY OF THE INVENTION

A method and system for enabling an image to be authenticated is disclosed. The method and system comprise providing a digital signature associated with a device, allowing a user to capture the image utilizing the device and associating the digital signature and information related to the user with the captured image wherein the digital signature and the information related to the user are capable of being utilized to authenticate the captured image.

Through the use of the method and system in accordance with the present invention, digital images can be captured whereby the digital signature of the capturing device, as well as information related to the photographer (i.e. name, company, etc.), are associated with the captured image. By associating the digital signature of the camera, as well as information related to the photographer, with the captured image, the subsequent authentication of the digital image is more reliable.

### BRIEF DESCRIPTION OF THE DRAWINGS

FIG. 1 shows a typical digital camera configuration.

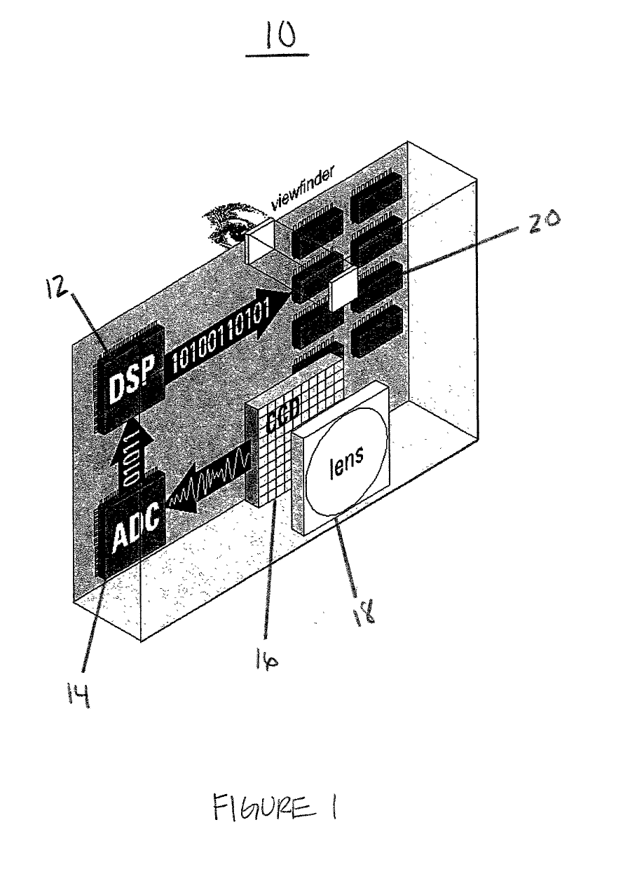

FIG. 2 is a high level flowchart of the method in accordance with the present invention.

FIG. 3 is a more detailed flowchart of step 104 of the flowchart of FIG. 2.

### DETAILED DESCRIPTION

The present invention relates to a method and system for enabling an image to be authenticated. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is presented in the context of a preferred embodiment. The preferred embodiment of the present invention is a method and system for enabling a digital image to be authenticated by incorporating information about a photographer of a digital image into the digital image. The present invention employs a mechanism that provides for the association of the identification of the photographer, company, time/date, or location of the image, with that particular digital image. By associating information related to the photographer, as well as the digital signature of the camera itself, with the captured image, the subsequent authentication of the digital image is more reliable.

Although the preferred embodiment of the present invention is described in the context of being used with a digital camera, one of ordinary skill in the art will readily recognize that the present invention could be utilized in conjunction with a scanner, a photocopier, or any device capable of electronically transmitting images while remaining within the spirit and scope of the present invention.

For example, such a method may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform a method for booting up a computer system in a secure fashion.

This computer readable media may comprise, for example, RAM (not shown) contained within the system. Alternatively, the instructions may be contained in another computer readable media such as a magnetic data storage diskette and directly or indirectly accessed by the system. Whether contained in the system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

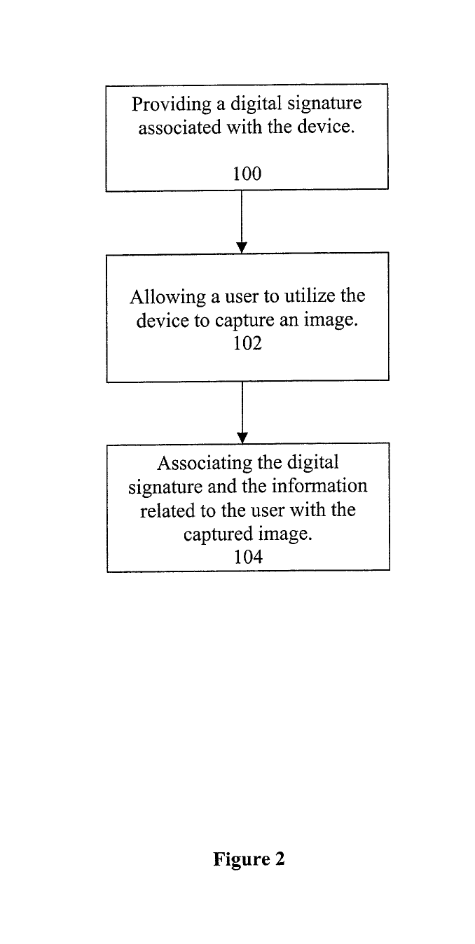

To further understand the method in accordance with the present invention, please refer now to FIG. 2. FIG. 2 is a high level flowchart of the method in accordance with the present invention. First, a digital signature associated with a device is provided, via step 100. Next, a user is allowed to utilize the device to capture an image, via step 102. Preferably, the device comprises a digital camera. Finally, the digital signature and information related to the user is associated with the captured image, via step 104. Accordingly, the digital signature and the information related to the user are capable of being utilized to authenticate the captured image.

The mechanism employed by the present invention preferably comprises a Radio Frequency (RF) interface or a smart card which is coupled to the digital camera as a means to allow the photographer's information (name, company, contract) to be obtained by the camera and associated with subsequent digital images. Additional information such as the location of the image could be transmitted to the camera from a Global Positioning System (GPS) and associated with the digital image via the RF interface or smart card. Furthermore, the camera could be equipped with a disabling mechanism whereby the camera is disabled unless it detects, via the RF interface or smart card, an approved photographer.

Resident on the smart card or RF interface, besides the photographer's information, is a personal public/private key pair unique to the photographer. The public key is mathematically related to the private key to permit the decrypting of the digital signature of the photographer. Therefore, when an image is captured by the camera, the image file is not only associated with the digital signature of the camera, but is also associated with the digital signature of the photographer.

Accordingly, when an image is captured by the camera, the image file and the digital signature of the camera are stored in memory of the camera. This piece of data (the image file and digital signature of the camera) are then sent through a hash algorithm thereby producing a digest. The digest is then passed to a digital signature engine and encrypted using the photographer's private key thereby creating a digital signature for the photographer. Now the photograph has been bound to a particular camera and a particular photographer. This creates a two-layer authentication process wherein the first layer of authentication is based on the digital signature of the camera and the second layer is based on the digital signature of the photographer.

The new image files would contain the image, the camera's digital signature, and the photographer's digital signature. This would allow a photographer's information to be indirectly added to a digital image since the photographer's public key is the only key that can authenticate or verify the image.

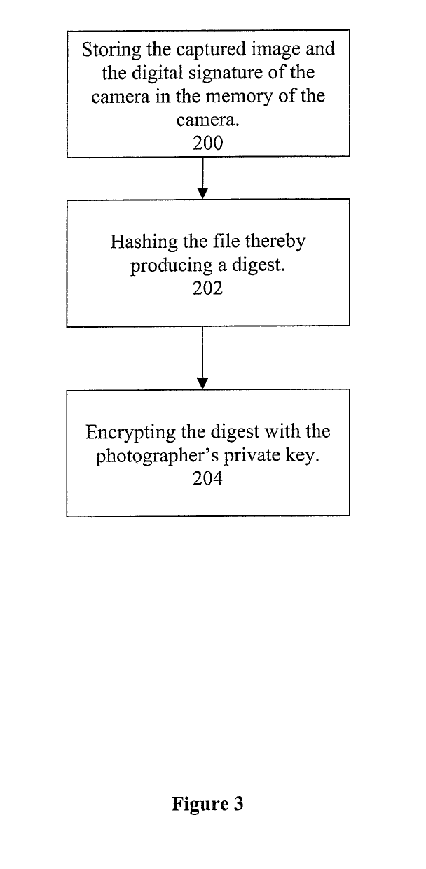

For a further understanding of the method in accordance with the present invention, please refer to FIG. 3. FIG. 3 is a more detailed flowchart of step 104 of the flowchart of FIG. 2. First, the captured image and the digital signature of the camera are stored in a file within the memory of the camera, via step 200. Next, the filed is hashed thereby producing a digest, via step 202. Finally, the digest is encrypted with the photographer's private key, via step 204.

Accordingly, one could determine the camera used to take the image by hashing the image, using the public key of the camera to decrypt the digital signature and then comparing the results of the decrypted signature and the results of the image hashing. If they are equal, the photograph is a non-modified original that came from the given camera. If they are not equal, the photograph is altered and the camera used cannot be determined or validated.

Similarly, one could determine the photographer who took the image by hashing the image and camera's digital signature, using the public key of the photographer to decrypt the digital signature created by the photographer and then compare the results of the decrypted signature and the results of the image hashing. If they are equal, the photograph is a non-modified original that came from the given photographer. If they are not equal, the photograph is altered and the photographer cannot be determined or validated.

Furthermore, the smart card/RF interface could also contain the public key and certificate of the owner or intended owners of photographs. For example, a photographer for Sports Illustrated could have Sports Illustrated's public key and certificate associated with the camera that she is using. Accordingly, each captured image is encrypted with the public key of Sport's Illustrated whereby only Sports Illustrated can view the image.

Through the use of the method and system in accordance with the present invention, digital images can be captured whereby the digital signature of the capturing device, as well as information related to the photographer (i.e. name, company, etc.), are associated with the captured image. By associating the digital signature of the camera, as well as information related to the photographer, with the captured image, the subsequent authentication of the digital image is more reliable.

Although the present invention has been described in accordance with the embodiments shown, one of ordinary skill in the art will readily recognize that there could be variations to the embodiments and those variations would be within the spirit and scope of the present invention.

Accordingly, many modifications may be made by one of ordinary skill in the art without departing from the spirit and scope of the appended claims.

What is claimed is:

1. A method for enabling an image to be authenticated, the method comprising the steps of:
a) providing a digital signature associated with a device;
b) allowing a user to capture the image utilizing the device; and
c) associating the digital signature and information related to the user with the captured image wherein the digital signature and the information related to the user are capable of being utilized to authenticate the captured image.

2. The method of claim 1 wherein the device is capable of electronically transmitting images.

3. The method of claim 2 wherein the device comprises a digital camera.

4. The method of claim 3 wherein the information related to the user comprises the user's identity.

5. The method of claim 4 wherein step c) further comprises:
c1) utilizing a radio frequency interface to associate the user's identity with the captured image.

6. The method of claim 5 wherein the radio frequency interface includes a public/private key pair associated with the user.

7. The method of claim 4 wherein step c) further comprises:
c1) utilizing a smart card to associate the user's identity with the captured image.

8. The method of claim 7 wherein the smart card includes a private key and a related public key wherein the private key and the related public key are associated with the user.

9. The method of claim 6 wherein step c1) further comprises:
c1a) associating the private key with the captured image.

10. The method of claim 8 wherein step c1) further comprises:
c1a) associating the private key with the captured image.

11. The method of claim 9 wherein step c1a) comprises the steps of:
1) storing the captured image and the digital signature in a file, wherein the file is located within a memory of the digital camera;
2) hashing the file thereby producing a digest; and
3) associating the digest with the private key.

12. The method of claim 10 wherein step c1a) comprises the steps of:
2) storing the captured image and the digital signature in a file, wherein the file is located within a memory of the digital camera;
2) hashing the file thereby producing a digest; and
3) associating the digest with the private key.

13. A system for incorporating information into an image, the system comprising:
means for producing a digital signature uniquely associated with a device;
means for allowing a user to utilize the device to capture the image; and
means for associating the digital signature and information related to the user with the captured image.

14. The system of claim 13 wherein the device is capable of electronically transmitting images.

15. The system of claim 14 wherein the device comprises a digital camera.

16. The system of claim 15 wherein the information related to the user comprises the user's identity.

17. The system of claim 16 wherein the means for associating further comprises:
means for utilizing a radio frequency interface to associate the user's identity with the captured image.

18. The system of claim 17 wherein the radio frequency interface includes a public/private key pair associated with the user.

19. The system of claim 15 wherein the means for associating further comprises:
means for utilizing a smart card to associate the user's identity with the captured image.

20. The system of claim 19 wherein the smart card includes a private key and a related public key wherein the private key and the related public key are associated with the user.

21. The system of claim 18 wherein the means for associating further comprises:
means for associating the private key with the captured image.

22. The system of claim 20 wherein the means for associating further comprises:
means for associating the private key with the captured image.

23. The system of claim 21 wherein the means for associating the private key with the captured image comprises:
means for storing the captured image and the digital signature in a file, wherein the file is located within a memory of the digital camera;
means for hashing the file thereby producing a digest; and
means for associating the digest with the private key.

24. The system of claim 22 wherein the means for associating the private key with the captured image comprises:
means for storing the captured image and the digital signature in a file, wherein the file is located within a memory of the digital camera;
means for hashing the file thereby producing a digest; and
means for associating the digest with the private key.

25. A computer readable medium containing program instructions for enabling an image to be authenticated, the program instructions comprising the steps of:
a) providing a digital signature associated with a device;
b) allowing a user to capture the image utilizing the device; and
c) associating the digital signature and information related to the user with the captured image wherein the digital signature and the information related to the user are capable of being utilized to authenticate the captured image.

26. The computer readable medium of claim 25 wherein the device is capable of electronically transmitting images.

27. The computer readable medium of claim 26 wherein the device comprises a digital camera.

28. The computer readable medium of claim 27 wherein the information related to the user comprises the user's identity.

29. The computer readable medium of claim 28 wherein step c) further comprises:
c1) utilizing a radio frequency interface to associate the user's identity with the captured image.

30. The computer readable medium of claim 29 wherein the radio frequency interface includes a public/private key pair associated with the user.

31. The computer readable medium of claim 28 wherein step c) further comprises:
c1) utilizing a smart card to associate the user's identity with the captured image.

32. The computer readable medium of claim 31 wherein the smart card includes a private key and a related public key wherein the private key and the related public key are associated with the user.

33. The method of claim 30 wherein step c1) further comprises:
c1a) associating the private key with the captured image.

34. The method of claim 32 wherein step c1) further comprises:
c1a) associating the private key with the captured image.

35. The computer readable medium of claim 33 wherein step c1a) comprises the steps of:
1) storing the captured image and the digital signature in a file, wherein the file is located within a memory of the digital camera;
2) hashing the file thereby producing a digest; and
3) associating the digest with the private key.

36. The computer readable medium of claim 34 wherein step c1a) comprises the steps of:
1) storing the captured image and the digital signature in a file, wherein the file is located within a memory of the digital camera;
2) hashing the file thereby producing a digest; and
3) associating the digest with the private key.
